(19) United States
(12) Patent Application Publication
(10) Pub. No.: US 2002/0140739 A1
(43) Pub. Date: Oct. 3, 2002

(54) System and method for communicating information to a device user

(76) Inventors: Kendra L. Dunlap, Tigard, OR (US); Mark M. Josephsen, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/825,602

(22) Filed: Apr. 3, 2001

(51) Int. Cl. G06F 3/14

(52) U.S. Cl. 345/810; 345/835

(57) ABSTRACT

The present disclosure relates to a system and method for communicating information to a device user. The method comprises the steps of presenting a textual indication to the user regarding a high level aspect of a device functionality, receiving an input from the user regarding the device functionality, and presenting a graphical indication to the user regarding a low level aspect of the device functionality. In a preferred embodiment, the device functionality pertains to the display and adjustment of device settings.

### FIELD OF THE INVENTION

The present disclosure relates to a system and method for communicating information to a device user. More particularly, the disclosure relates to a system and method for providing both textual and graphical information to a user of a peripheral device with a device display screen.

### BACKGROUND OF THE INVENTION

Peripheral devices such as printers, photocopiers, facsimile machines, and digital senders typically comprise display screens with which information is communicated to the device user about the operation of the device as well as the current settings of the device. By way of example, this information is presented to the user with text or graphical indications presented in the display screens. In that the display screens on such devices are normally small, and to avoid requiring the user to read a large amount of text, this information often is communicated with a minimum of words or symbols. Because of this fact, these indications can often be cryptic and therefore difficult for the user to understand. For instance, although relatively few words can be used to clearly convey high level functionality (e.g., the words “contrast control” for identifying a button used to adjust contrast), it is difficult to convey low level information in a concise manner (e.g., conveying a current contrast setting of the device). Although graphical representations can be useful in conveying such low level information, graphical representations are not as useful for conveying high level functionality.

Although the user can determine the meaning of text and graphical indications presented to the user by referring to an operations manual, it is considered preferable for the indications to be as intuitive as possible to obviate the need for such reference. In addition, although familiarity with a particular device normally brings familiarity with the display screen indications, new users may still have difficulty in understanding their meanings. Accordingly, it can be appreciated that it would be desirable to have a system and method for communicating information via a device display screen in a clear and intuitive manner such that the user can easily understand the meaning of the communication.

### SUMMARY OF THE INVENTION

The present disclosure relates to a system and method for communicating information to a device user. In one embodiment, the method comprises the steps of presenting a textual indication to the user regarding a high level aspect of a device functionality, receiving an input from the user regarding the device functionality, and presenting a graphical indication to the user regarding a low level aspect of the device functionality. In a preferred embodiment, the device functionality pertains to the display and adjustment of device settings.

In one arrangement, the system comprises means for presenting a textual indication to the user regarding a high level aspect of a device functionality, means for receiving an input from the user regarding the device functionality, and means for presenting a graphical indication to the user regarding a low level aspect of the device functionality. In another arrangement, the system comprises logic configured to present a textual indication to the user regarding a high level aspect of a device functionality, logic configured to receive an input from the user regarding the device functionality, and logic configured to present a graphical indication to the user regarding a low level aspect of the device functionality.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic that illustrates an environment for the system and method of the present invention.

FIG. 2 is a schematic that illustrates an example architecture of a peripheral device shown in FIG. 1.

FIG. 3 is a schematic that illustrates an example control panel of the peripheral device shown in FIGS. 1 and 2.

FIG. 4 is a flow chart that illustrates the operation of an information communication module shown in FIG. 2.

FIG. 5 is a schematic that illustrates an example default screen that can be shown in the display of the peripheral device shown in FIGS. 1 and 2.

FIG. 6 is a schematic that illustrates an example scale/contrast adjustment screen that can be shown in the display of the peripheral device shown in FIGS. 1 and 2.

FIG. 7 is a schematic that illustrates the default screen of FIG. 5 after device settings have been changed through use of the adjustment screen of FIG. 6.

### DETAILED DESCRIPTION

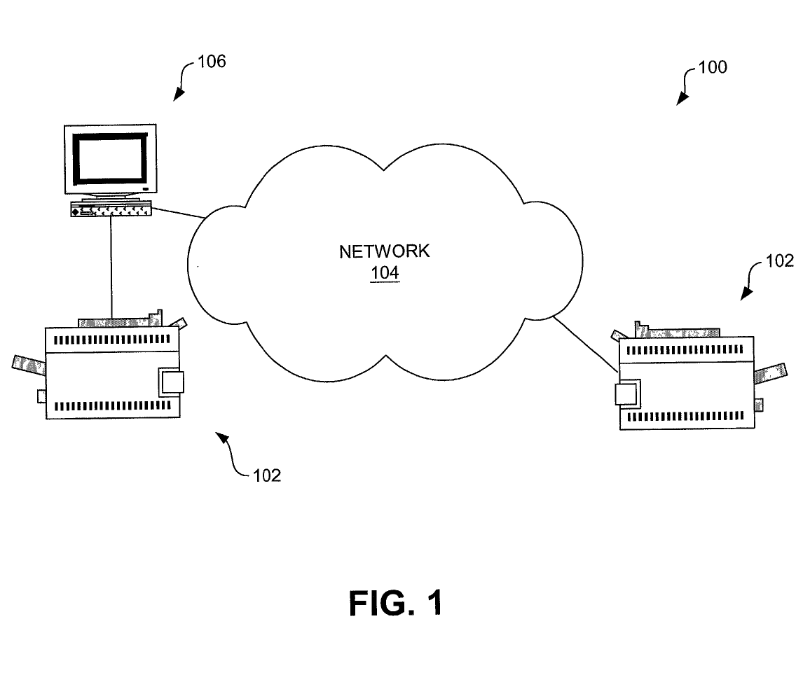

Referring now in more detail to the drawings, in which like numerals indicate corresponding parts throughout the several views, FIG. 1 illustrates an example environment 100 in which the system and method the present invention can be used. In particular, the system and method will be described as being implemented in a peripheral device 102 that, as indicated in FIG. 1, can be connected to a network 104 and/or directly connected to a computing device 106. In a preferred arrangement, the peripheral device 102 comprises a multi-function peripheral (MFP) device capable of two or more functions normally provided by separate and distinct machines. Although an MFP device is preferred, it will be understood from the discussion that follows that the functionality provided by the inventive system and method could, alternatively, be utilized in substantially any peripheral device as well as other electrical devices that convey information to the user with a display screen.

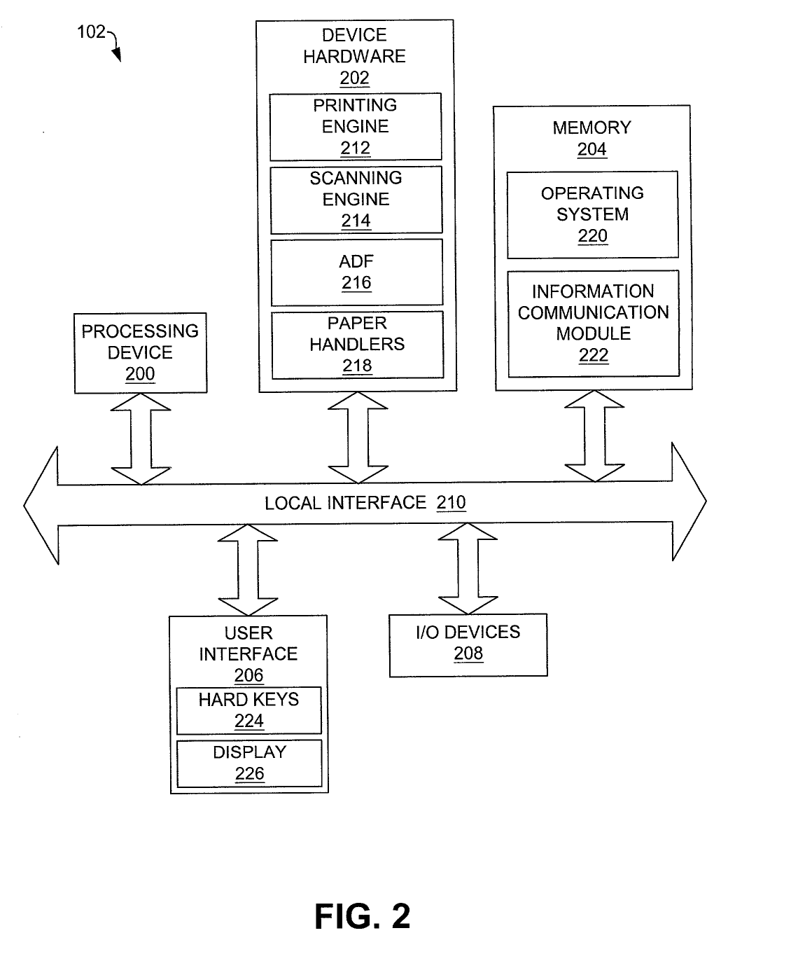

FIG. 2 is a schematic illustrating an example architecture for the peripheral device 102 shown in FIG. 1. As indicated in FIG. 2, the peripheral device 102 comprises a processing device 200, device hardware 202, device memory 204, a user interface 206, input/output devices 208, and a local interface 210 (e.g., one or more internal buses) to which each of the other components electrically connects. The processing device 200 is adapted to execute commands stored in memory 204 and can comprise a general-purpose processor, a microprocessor, one or more application-specific integrated circuits, and/or other known electrical configurations. The device hardware 202 includes various components used to facilitate the operation of the device 102. For instance, the device hardware 200 can include various components used to convert electronic information into hardcopy, such as a printing engine 212, and paper handlers 218, and components used to facilitate the transformation of hardcopy documents into electronic form such as a scanning engine 214 and an automatic document feeder (ADF) 216. It is to be understood, however, these components are presented for purposes of example only, and not by way of limitation, and that the hardware the peripheral device 102 includes is largely dependent on the type of functionality the device provides.

The user interface 206 typically comprises user interface tools such as hard keys 224 and a display 226 with which a user can input various commands and settings. The display 226 can comprise, for example, a liquid crystal display (LCD), a touch sensitive screen, a light emitting diode (LED) display, or combinations thereof. The input/output (I/O) devices 208 can include electrical interface elements for receiving electronic information from, by way of example, a computing device such as that illustrated in FIG. 1, where the peripheral device is adapted for printing. Furthermore, the input/output devices 208 typically include electrical interface elements for transmitting electronic information from the peripheral device 102 to other devices that are connected to the device either directly or indirectly (e.g., over a network). For instance, these interface elements can include a modem adapted to send data via e-mail or fax to a computing device and facsimile machine, respectively.

As identified in FIG. 2, the device memory 204 comprises a device operating system 220 that contains the various execution commands necessary to control the device hardware and its operation. In addition, the device memory 204 includes an information communication module 222 that is adapted to present textual and graphical information to the user of the peripheral device 102. The device operating system 220 and the information communication module 220 each can be implemented in software, firmware, or a combination thereof. In a preferred embodiment, the information communication module 220 is implemented in firmware stored in the device memory 204. It is to be appreciated that, where the functionality selection module 220 is implemented in either software, firmware, or both, the information communication module can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

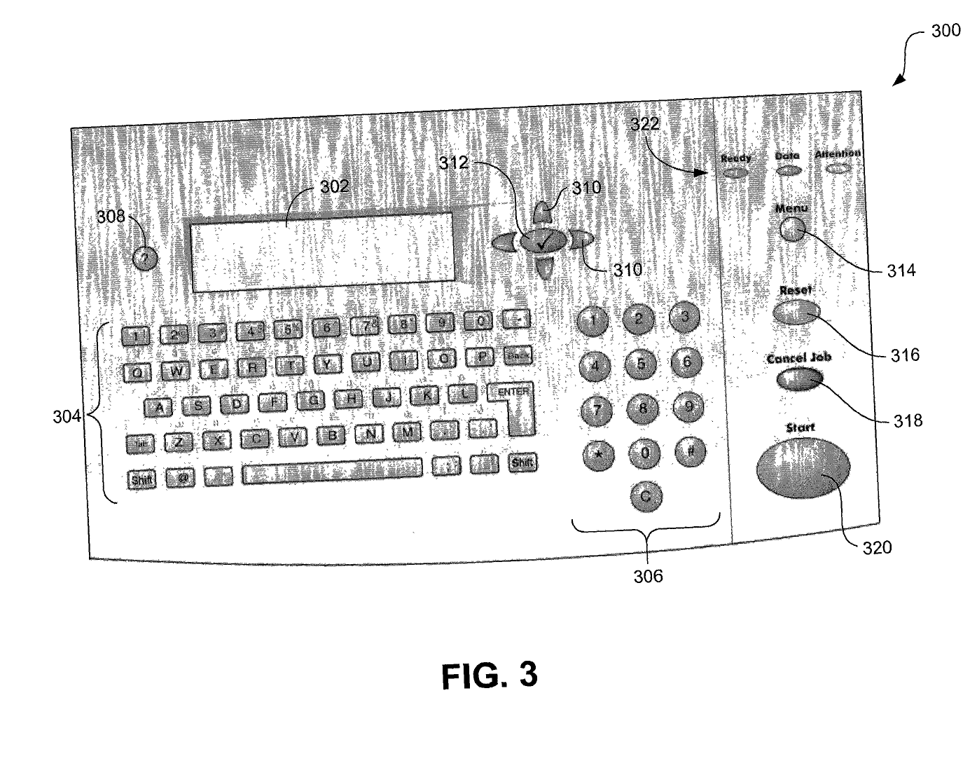

FIG. 3 illustrates an example control panel 300 of the peripheral device 102 that can be used to facilitate user interface with the device. As identified in this figure, the control panel 300 normally includes a display screen 302 with which information can be presented to the user and with which commands can be communicated to the peripheral device 102. In a preferred arrangement, the display screen 302 comprises an LCD. In addition to the display screen 302, the control panel 300 can include a keyboard 304 with which the user can enter various alphabetic and numeric characters. By way of example, this keyboard 304 typically is a QWERTY type keyboard, although it will be appreciated that other keyboard styles would also be suitable. In addition to the keyboard 304 is a numeric keypad 306 with which the user can enter numeric characters. As identified in FIG. 3, the numeric keypad 306 is normally arranged in similar manner to those found on conventional push-button telephones.

In addition to the keyboard 304 and numeric keypad 306, the control panel 300 normally further includes a help button 308 with which the user can access tutorial information presented with the display screen 302, a series of directional keys 310 with which the user can navigate various menus presented via the display, and a select button 312 with which the user can select an item from one of these menus. The control panel 300 can additionally include a menu button 314, a reset button 316, a cancel job button 318, and a start button 320. The menu button 314 can be used to access the various menus that are presented to the user with the display screen 302. The reset button 316 resets the peripheral device 102 after information has been entered by the user or various selections have been made. The cancel job button 318 is used to cancel a task that the peripheral device 102 has begun to execute (e.g, a print job, a photocopy job, an e-mail job, or a fax job). Finally, the start button 320 is used to initiate a task to be performed by the peripheral device 102. In addition to buttons, the control panel 300 can further include indicator lights 322 that identify the operational status of the peripheral device 102. For instance, the indicator lights 322 can indicate that the device 102 is ready, that the data is being received or sent, or that there is a problem that calls for the user's attention.

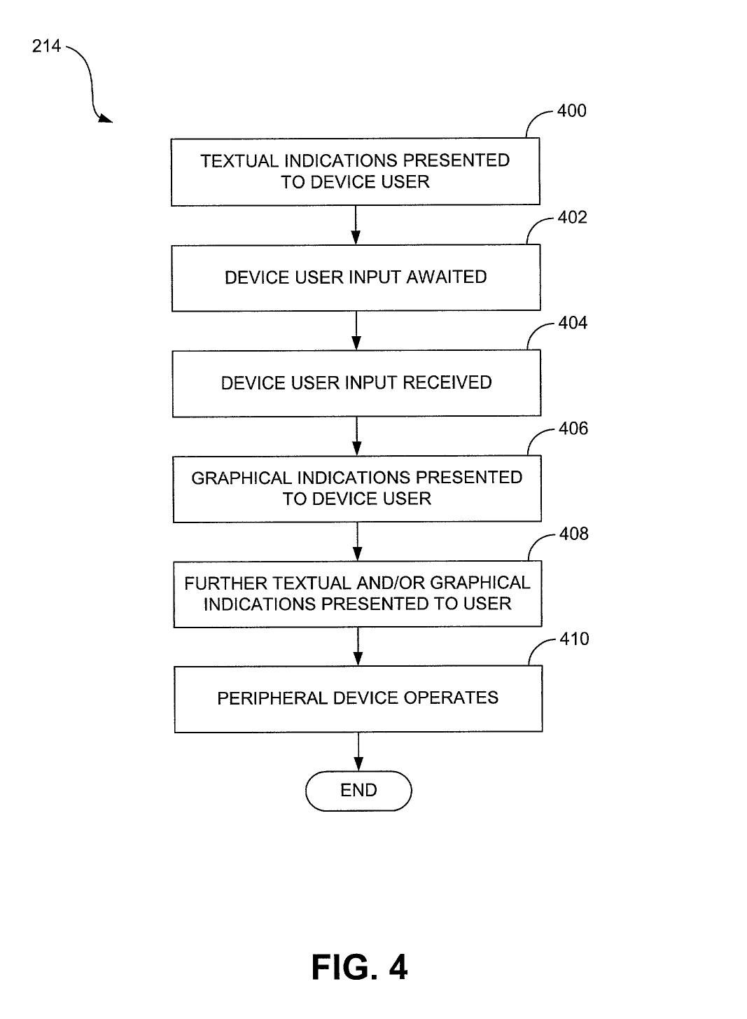

FIG. 4 is a flow diagram that illustrates the operation of the information communication module 214 shown in FIG. 2. This module 214 is used to present textual and graphical information to the device user. Simultaneous display of text and graphics is highly effective for conveying information. However, where space is limited, it may not be feasible to present both text and graphics to the user at the same time. Unfortunately, as highlighted above, textual and graphical indications are not necessarily effective for communicating all types of information when used independently of each other. For instance, although words can adequately describe a functionality, long descriptions are undesirable due to the burden placed upon the user to read them and due to space limitations. Similarly, graphics can convey much information to the user, but only if the user is familiar with the symbol or symbols used in the graphics (i.e., where the user has learned the meaning of graphics). It has, however, been determined that advantageous results can be achieved when textual and graphical indications are used separately, but in conjunction with each other to convey information to the user. As the discussion of the example screens presented below elucidates, particularly advantageous results are obtainable where textual indications are used to convey high level information (e.g., how to initiate a particular functionality), and graphical indications are later used to convey low level information (e.g., feedback as to changes the user made to the functionality). Therefore, as will be made apparent below, the information communication module 214 is adapted to initially present textual indications at a high level and later present graphical indications at a low level with regard to a particular functionality.

As indicated in block 400 of FIG. 4, the information communication module 214 first presents the device user with textual indications as to the high level operations of the peripheral device 102. Typically, these indications are presented in the display screen 302 of the device 102 upon initiation of the device 102 (e.g., by placing a document in the device). By way of example, textual indications can be provided as to various buttons displayed in the display screen 302 and used to review and/or adjust the settings of the device 102. These settings can include the size of the original document, the size of a photocopy that is to be produced by the device 102, the scale the photocopy is to have, the contrast with which the copy is to made, etc. Once the textual indications are presented, the information communication module 214 awaits input from as user, as indicated in block 402. Normally, this input occurs through selection of one or more buttons provided on the control panel 300. In a preferred embodiment, this selection is made by selecting a highlighted button shown in the display screen 302 by manipulating the directional buttons 310 and the select button 312.

Once a user input is received, as indicated in block 404, the information communication module 214 presents the user with graphical indications as to the low level aspects of the device functionality that was selected by the user, as indicated in block 406. In addition to graphical indications, the user can further be presented with textual indications that accompany the graphical indications. Typically, the graphical indications are presented to the user in response to selection of a high level functionality button initially presented in the display screen 302. By way of example, where a contrast button is selected, the information communication module 214 presents the user with graphical (and, optionally, textual) indications as to the current contrast setting for the peripheral device 102. Operating in this manner, the user is provided with both textual and graphical indications that, together, clearly convey information to the user about the operation and the settings of the device 102. At this point, the user can make further selections in the manner described above and the information communication module 214 can present further graphical indications for low level functionality or textual indications for high level functionality, as the case may require, as indicated in block 408. After all desired selections have been made, the peripheral device can operate, as indicated in block 410, to provide the desired functionality (e.g., photocopying, e-mailing, faxing).

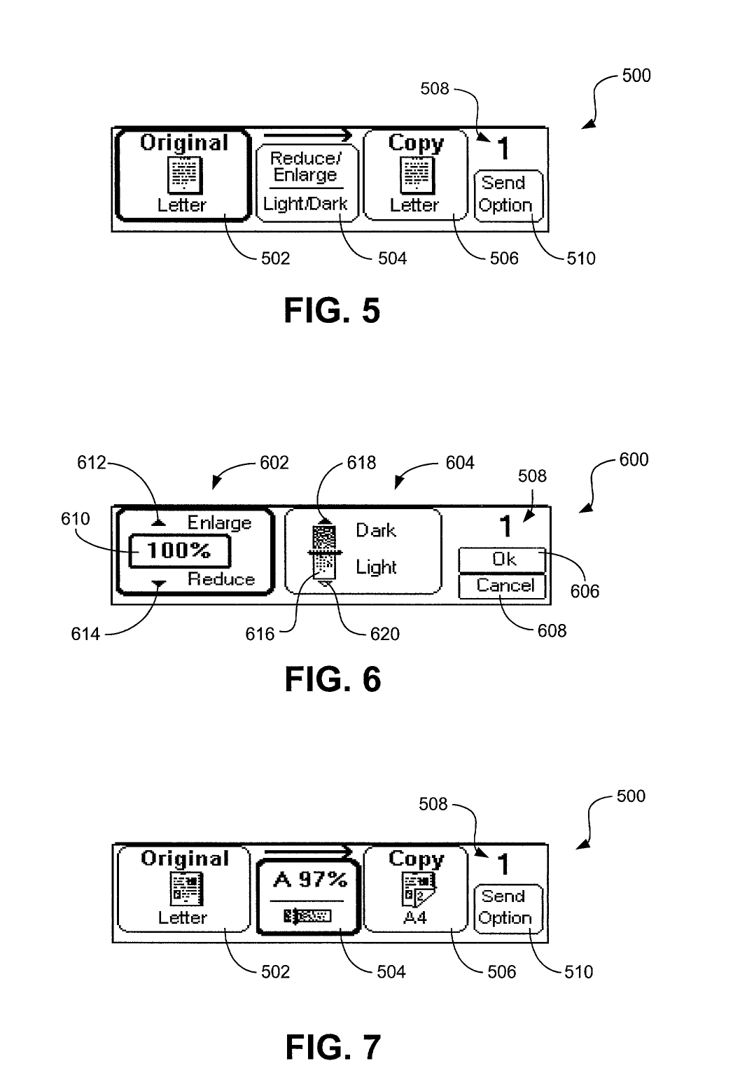

FIGS. 5-7 illustrate various screens that exemplify the functionality described above w/ reference to FIG. 4. Normally, these screens are presented to the user with the display screen 302 of the control panel 300. With reference first to FIG. 5, a default screen 500 is illustrated. By way of example, this default screen 500 can be displayed to the user whenever a document is inserted into the peripheral device 102, e.g., by placing a single page document on a platen of the device or by inserting a multiple page document into an automatic document feeder. As indicated in FIG. 5, the default screen 500 includes an original settings button 502 identified with the text “Original”, a scale/contrast button 504 identified with the text “Reduce/Enlarge” and “Light/Dark”, a copy settings button 506 identified with the text “Copy”, a copy number indicator 508 comprising a numeral, and a send options button 510 identified with the text “Send Option”. The original settings button 502 is used to view and modify the settings for the original document that has been placed in the peripheral device 102 by the user. In the example provided in FIG. 5, the original settings button 502 textually indicates that the device 102 is configured for an original that is “Letter” sized (i.e., 8.5×11 inches). The copy settings button 506 is used to view and modify the settings for a photocopy that will be made of the original document if a photocopying functionality is selected by the user. In the example provided in FIG. 5, the copy settings button 506 textually indicates that the device 102 is configured for making copies that also are “Letter” sized. As its name suggests, the scale/contrast button 504 is used to view and modify the settings associated with the scaling (i.e., reduction/enlargement) that will be effected when a copy is made of the original documents, and the contrast (i.e., lightness/darkness) the copy will have. In the example provided in FIG. 5, the scale/contrast button 504 textually indicates that the device 102 is configured to function (e.g., make copies) at default scale and contrast settings, e.g., 100% scale and 50% contrast. Finally, the copy number indicator 508 is used to convey the number of copies that will be made of the original document. Where the user does not wish to make a photocopy and, more particularly, wishes to digitally send the documents via e-mail or fax, the user can select the send options button 510 to be presented with these sending options.

FIG. 6 illustrates a scale/contrast adjustment screen 600 that can be used to change the current scale and contrast settings. By way of example, the user is presented with the adjustment screen 600 after selecting the scale/contrast button 504 shown in FIG. 5. Like the default setting screen 500, the scale/contrast adjustment screen 600 includes a copy number indicator 508. However, unlike the default screen 500, the scale/contrast adjustment screen 600 includes an independent scale button 602 and an independent contrast button 604, as well as “Ok” and “Cancel” buttons 606 and 608. As indicated in FIG. 6, both the scale button 602 and the contrast button 604 include textual and graphical indications to communicate the current settings to the user as well as indicate how these settings can be changed by the user. Accordingly, the user is first presented with text from the scale/contrast button 504 at the default screen 500, and then provided with graphics with the scale and contrast buttons 602 and 604 at the adjustment screen 600. By way of example, the scale button 602 includes a current setting window 610, an up arrow 612 labeled “Enlarge”, and a down arrow 614 labeled “Reduce”. As these textual and graphical indications suggest, the scale with which a photocopy will be made can be increased by selecting the up arrow 612, or decreased by selecting the down arrow 614. As this scale is adjusted, the current value is displayed in the setting window 610.

The contrast button 604 includes a contrast level indicator 616 that, as indicated in FIG. 7, typically comprises a vertical bar that gradually progresses from a light color at its bottom to a dark color at its top, and a horizontal bar that crosses the vertically aligned bar at a particular position along its length. At the top end of the level indicator 616 is an up arrow 618, and at the bottom end of the indicator is a down arrow 620. Adjacent the up and down arrows 618 and 620 are “Dark” and “Light” labels, respectively. As these indications suggest, the contrast of copies to be made with the device 102 can be adjusted by moving the horizontal bar up or down along the vertical bar to increase or decrease the contrast, respectively.

FIG. 7 illustrates the default screen 500 of FIG. 5 after various settings of the peripheral device 102 have been changed by the user by making selections at the adjustment screen 600. As shown in FIG. 7, the copy settings button 506 has changed to textually indicate that the device 102 is now configured for making copies that also are “A4” sized. In addition, a graphical indication is provided to the user, in the form of a turned-up corner on a page, that the device 102 is configured to make duplex (i.e., two-sided) copies. In addition to these changes, the scale/contrast button 504 both textually and graphically indicates the changed settings of the device 102 to provide the user with feedback as to the selections he or she has made. In the example provided in FIG. 7, the scale/contrast button 504 indicates that the scaling has been automatically, indicated with the letter “A”, configured for 97% scale to accommodate the difference between the “Letter” sized original and the “A4” sized copy, and that the contrast has been moved to a darker contrast, indicated with a contrast level indicator 700. Notably, the scale/contrast button 504 previously presented only text to the user (see FIG. 5). In that the user already accessed the scale and contrast functionalities by first selecting the textual scale/contrast button 504 from the default screen 500, the user typically will understand the meaning of the graphical indications now provided in the button (FIG. 7). Stated in other words, the user learns the meaning of the graphical indications by first being presented with textual indications and then being presented with the graphical indications in the same button.

As the example screens of FIGS. 5-7 show, information can be more clearly conveyed by presenting both textual and graphical information to the user. Moreover, it can be appreciated that particularly advantageous results can be achieved when the user is first presented with text with respect to the high level aspects of a particular functionality, e.g., providing an indication of how to adjust a particular device setting, and later presented with graphics or graphics/text in relation to the low level aspects of the functionality, e.g., providing the user with feedback as to a new setting that has been selected by the user. Although particular embodiments of the invention have been disclosed in detail in the foregoing description and drawings for purposes of example (e.g., FIGS. 5-7), it will be understood by those skilled in the art that variations and modifications thereof can be made without departing from the scope of the invention as set forth in the following claims.

What is claimed is:

1. A method for communicating information to a device user, comprising:
presenting a textual indication to the user regarding a high level aspect of a device functionality;
receiving an input from the user regarding the device functionality; and
presenting a graphical indication to the user regarding a low level aspect of the device functionality.

2. The method of claim 1, wherein the step of presenting a graphical indication to the user regarding the device functionality further comprises the step of presenting a textual indication along with the graphical indication.

3. The method of claim 1, wherein the device functionality pertains to displaying and facilitating adjustment of a device setting.

4. The method of claim 3, wherein the textual indication is provided within a button that when selected displays the graphical indication to the user.

5. The method of claim 4, wherein the graphical indication conveys a current value of the device setting to the user.

6. The method of claim 4, wherein the graphical indication is used to facilitate adjustment of the device setting.

7. The method of claim 3, wherein the device setting comprises the scale of a copy produced by the device.

8. The method of claim 3, wherein the device setting comprises the contrast of a copy produced by the device.

9. A system for communicating information to a device user, comprising:
means for presenting a textual indication to the user regarding a high level aspect of a device functionality;
means for receiving an input from the user regarding the device functionality; and
means for presenting a graphical indication to the user regarding a low level aspect of the device functionality.

10. The system of claim 1, wherein the means for presenting a graphical indication to the user regarding the device functionality further comprises means for presenting a textual indication along with the graphical indication.

11. The system of claim 1, wherein the device functionality pertains to displaying and facilitating adjustment of a device setting.

12. The system of claim 3, wherein the textual indication is provided within a button that when selected displays the graphical indication to the user.

13. The system of claim 4, wherein the graphical indication conveys a current value of the device setting.

14. The system of claim 4, wherein the graphical indication is used to facilitate adjustment of the device setting.

15. The system of claim 3, wherein the device setting comprises the scale of a copy produced by the device.

16. The system of claim 3, wherein the device setting comprises the contrast of a copy produced by the device.

17. A system, including computer readable media, for communicating information to a device user, comprising:
logic configured to present a textual indication to the user regarding a high level aspect of a device functionality;
logic configured to receive an input from the user regarding the device functionality; and
logic configured to present a graphical indication to the user regarding a low level aspect of the device functionality.

18. The system of claim 17, wherein the logic configured to present a graphical indication to the user regarding the device functionality further comprises logic configured to present a textual indication along with the graphical indication.

19. The system of claim 17, wherein the device functionality pertains to displaying and facilitating adjustment of a device setting.

20. The system of claim 19, wherein the textual indication is provided within a button that when selected displays the graphical indication to the user.

21. The system of claim 20, wherein the graphical indication conveys a current value of the device setting.

22. The system of claim 20, wherein the graphical indication is used to facilitate adjustment of the device setting.

23. The system of claim 19, wherein the device setting comprises the scale of a copy produced by the device.

24. The system of claim 19, wherein the device setting comprises the contrast of a copy produced by the device.

25. A peripheral device, comprising:
a control panel having a display screen with which information is presented to a device user; and
an information communication module adapted to present device setting buttons containing textual indications as to the type of setting to which each button pertains, and further adapted to present a graphical indication as to the setting to which a button pertains upon selection of the button via the control panel.
